(19) United States
(12) Patent Application Publication
(10) Pub. No.: US 2007/0294834 A1
(43) Pub. Date: Dec. 27, 2007

(54) Apparatus And Method For Removing Fittings For Pipes

(76) Inventor: Paul Fenton, Merseyside (GB)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/588,931

(22) PCT Filed: Feb. 10, 2005
(86) PCT No.: PCT/GB05/00466

§ 371 Date: May 24, 2007

(30) Foreign Application Priority Data
Feb. 11, 2004 (GB) 0402990.6

(51) Int. Cl. B25B 13/10

(52) U.S. Cl. 7/140

(57) ABSTRACT

Apparatus (10) for removing a friction grip fitting (56) from a pipe (50) comprises a first engagement means (16, 18) for directly or indirectly engaging the friction grip fitting, a second engagement means (34) for engaging the end of the pipe at a position spaced-apart from the friction grip fitting and means (24) for applying a force to move the first and second engagement means with respect to one another to slide the friction grip fitting with respect to the pipe.

The present invention relates to an apparatus and method for removing fittings from pipes, and in particular, but not exclusively, to an apparatus and method for removing olives (compression rings) from pipes.

Olive joints are commonly used for connecting pipes to pipes and pipes to fittings, such as radiator valves, to pipes. An olive joint generally comprises a fitting (e.g. a valve) and a screw-threaded ring. The screw-threaded ring is fed onto the pipe, followed by a deformable ring (or “olive”). The fitting is then positioned on the end of the pipe and the ring is then screwed onto the fitting. The fitting and ring each have an abutment surface (e.g. a taper or flange) arranged to bear against respective sides of the olive. Thus, when the two parts of the joint are screwed together, the olive is compressed between the abutment surfaces and onto the pipe. Intimate contact is thereby made between the olive, the pipe and each abutment surfaces, which creates a seal.

It is not normally possible to remove the olive, once installed, because the plastic deformation creates a very intimate friction fit between the olive and the pipe. Moreover, localised welding may occur as a result of work hardening/heating during plastic deformation.

The present invention relates also to e.g. collars, rings, bearings, bushes and other such fittings that may be fitted and removed from e.g. pipes, shafts, bars etc. It is to be appreciated, therefore, that the teachings of the present invention may apply equally to other such analogous situations, and not just to pipe olives.

Collars and rings etc. are sometimes installed on, say, a pipe, by selecting one of a slightly smaller internal diameter than the external diameter of the pipe, and heating it, (e.g. using blowtorch). Heating the ring causes it to expand to an extent that its inner diameter exceeds the external diameter of the pipe. The ring can then be relatively easily positioned on the pipe and allowed to cool. As it cools, it contracts onto the pipe forming a very tight interference or friction fit therewith.

It is not, however always possible to remove the ring by a reverse process (i.e. heating it to expand it off the pipe) because in doing so, the pipe is also heated, causing the pipe to expand to substantially the same degree as the ring, thereby negating the expansion effect.

Accordingly, friction grip fittings, such as those above-described, olives and rings, once installed, can be difficult to remove.

Sawing through the friction grip fitting or pipe below the fitting is rarely desirable. Moreover, sawing can be difficult as it is not always possible to gain sufficient access to the friction grip fitting or pipe to use a saw effectively. Moreover, if the pipe is cut, it may need to be extended to bring the end back to its original position (e.g. to join it back onto a radiator fitting).

Alternatively, a friction grip fitting (e.g. an olive) can sometimes be removed by applying a force on one part of the fitting in the direction of the pipe axis. Again, gaining access to the fitting can be difficult making it difficult and sometimes unsafe to carry out the operation. Furthermore, it can be difficult to apply a purely axially directed force to the olive, which as a consequence, results in the olive biting into the pipe rather than sliding along it.

It is therefore an object of the present invention to provide a solution to one or more of the above problems.

Accordingly, a first aspect of the present invention provides an apparatus for removing a friction grip fitting from a pipe comprising a first engagement means for directly or indirectly engaging the friction grip fitting, a second engagement means for engaging the end of the pipe at a position spaced-apart from the friction grip fitting and means for applying a force to move the first and second engagement means with respect to one another to slide the friction grip fitting with respect to the pipe.

A second aspect of the present invention provides a method for removing a friction grip fitting from a pipe comprising the steps of;

directly or indirectly engaging the friction grip fitting with an engagement means;

engaging the end pipe at a position spaced-apart from the friction grip fitting; and

exerting a force between the friction grip fitting and the end of the pipe such that the friction grip fitting slides with respect to the pipe.

Preferably, the apparatus for removing a fiction grip fitting from a pipe has a body. The body preferably has first and second spaced ends and means connecting said ends. In one preferred embodiment the body is generally C-shaped to provide said ends and connecting means. In another preferred embodiment the body comprises one half of a cylinder with said ends mounted to the top and bottom of said half cylinder. Preferably one of said ends provides the first engagement means. The first engagement means may comprise a bifurcated end or a pair of forks or prongs adapted to engage with the fitting. The first engagement means may further comprise a collet member specifically adapted to engage a certain type of pipe fitting. The collet, where provided, may be split into two or more parts.

The second engagement means preferably comprises a mandrel (i.e. a pipe end abutment means/a pipe end abutment and support means). The mandrel, where provided, preferably has neck and shoulder portions adapted to slide into the end of a pipe and to bear against the end of the pipe respectively. The diameter of the shoulder is preferably selected to correspond with or to exceed the external diameter of the pipe. The diameter of the neck portion is preferably selected to correspond with the internal diameter of said pipe.

A plurality of shoulders and necks may be provided such that a single mandrel may accommodate various sized pipes. I.e. the second engagement means may comprise a stepped diameter shank. A groove is preferably provided at the interface between shoulder and neck portions to prevent the internal edge end of the pipe being deformed during use.

The means for applying a force to move the first and second engagement means with respect to one another to slide the fitting with respect to the pipe may be any mechanical means capable of providing a substantially linear force between the first and second engagement means (i.e. in a direction substantially along the axis of the pipe). Any suitable means may be provided, e.g. a piston, however it is envisaged that a stud acting between the first and second engagement means would be preferred. The stud, where provided, may be arranged to engage with a fixed part of the apparatus and one of the engagement means. The fixed part of the apparatus is preferably said second end of the body.

In a preferred embodiment, a stud is provided that passes through a threaded aperture in the body of the invention and has a mandrel attached to an end thereof. A torque can be applied to the stud, e.g. using a cross bar, to wind the stud either towards or away from an opposing engagement means, as desired.

The mandrel is preferably removable and/or interchangeable with mandrels of differing sizes and/or geometries to suit the application. Where the mandrel is removable, may be provided with a push or snap fit connector. Preferably, however, the mandrel is provided with a grub-screw adapted to engage with a groove or other formation in the stud.

In use, the first engagement means is arranged to abut against the pipe fitting and the second engagement means is arranged to engage with the pipe.

By way of example, the stud may be rotated using the cross bar to causes the neck of the mandrel to slide within the end of the pipe, and eventually to cause the shoulder of the mandrel to engage with the end of the pipe. Continuing to rotate the stud causes the forks or collet to bear against the fitting imparting a sliding force thereto and the olive slides off the end of the pipe.

It is possible that the apparatus of the invention will be manufactured largely or entirely of a, stiff, strong, resilient material such as steel. However, the apparatus may be manufactured from a plastics material in certain circumstances. It is also a possibility that the apparatus will be sold as a kit of parts comprising some or all or more than one of the following items: body, stud, mandrel or mandrels, collet or collets and/or an allen key for adjusting the grub-screw, where provided.

The apparatus of the invention may be provided with height adjustable means for supporting a pipe during sweating up thereof to join same to another pipe or a pipe junction. Such support means may be a saddle or the like on the stud so that the body of the apparatus can be used as a base and the stud rotated to position the saddle at a suitable height to support the pipe.

The invention will now be further described, by way of example only, with reference to the accompanying drawings, in which;

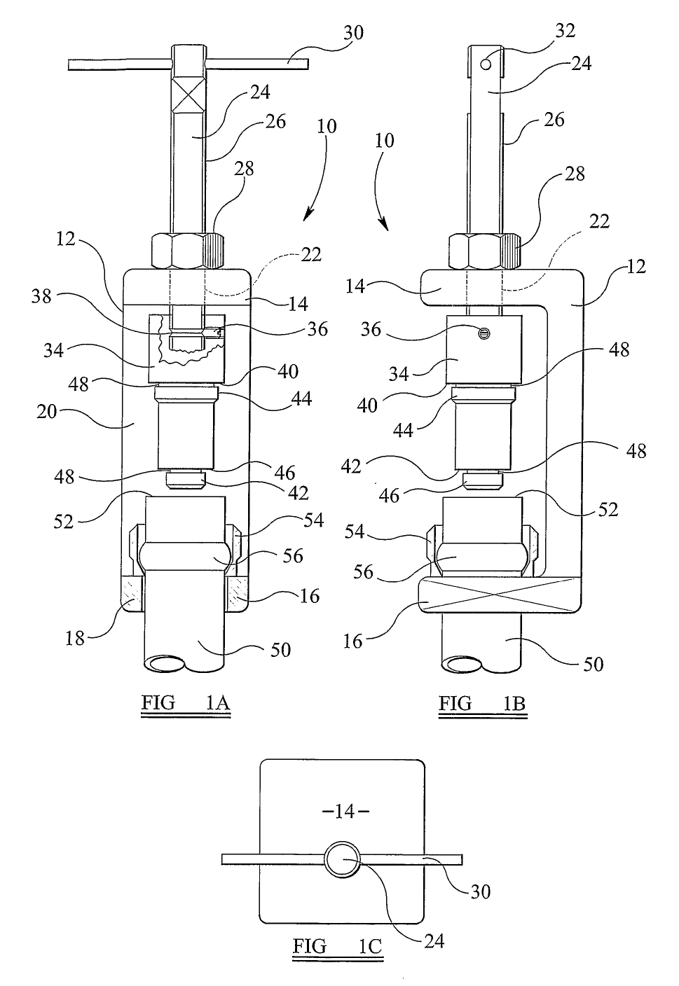

FIGS. 1A, 1B and 1C show respectively front, side and plan elevations of a first embodiment of the invention in orthographic projection;

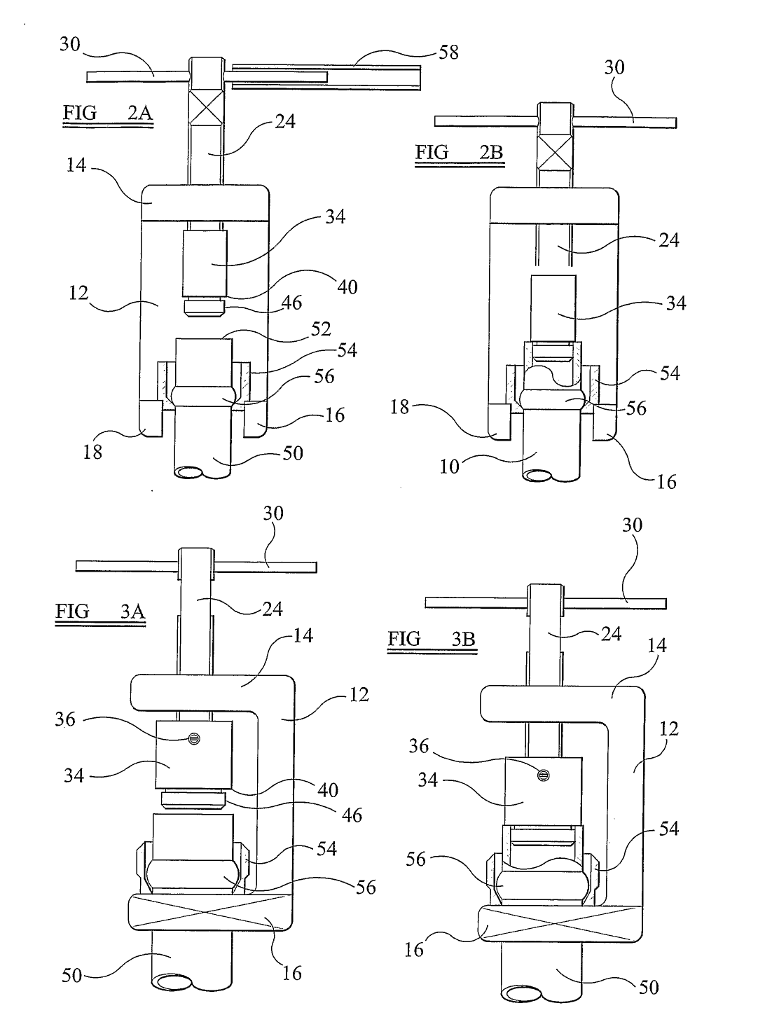

FIGS. 2A and 2B show front elevations of a second embodiment of the invention in use on a small diameter pipe;

FIGS. 3A and 3B show front elevations of a second embodiment of the invention in use on a larger diameter pipe;

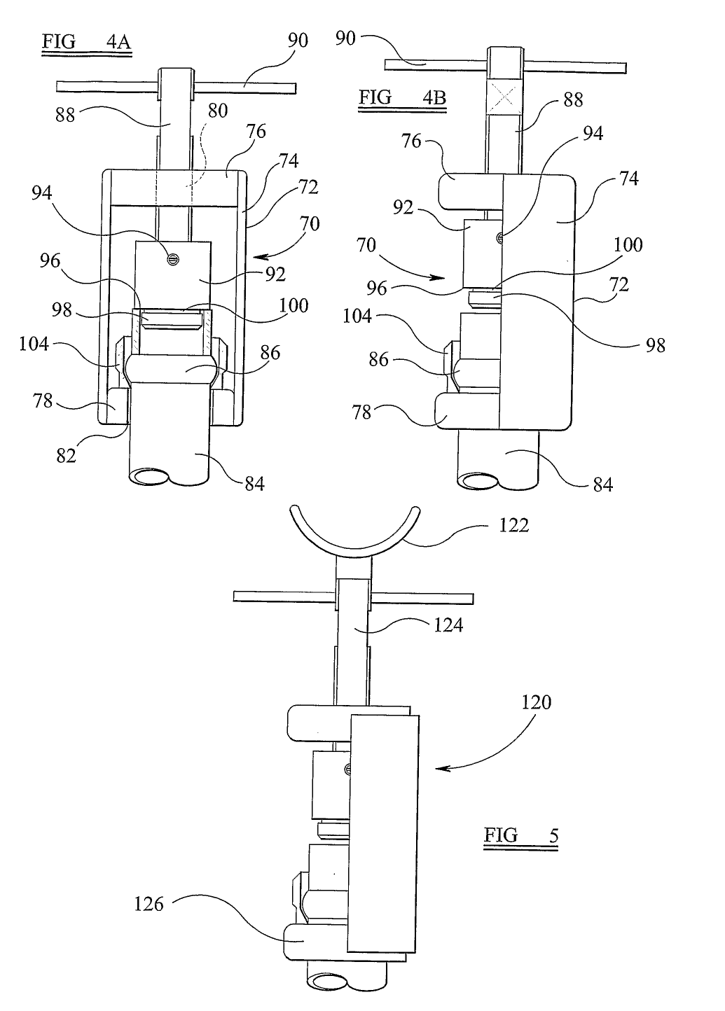

FIGS. 4A and 4B show respectively front and side elevations of a third embodiment of the invention; and

FIG. 5 shows an optional feature for apparatus of the invention.

FIGS. 1A, 1B and 1C show an apparatus for removing fittings from pipes according to the invention 10 having a body 12 comprising plate 14 and a bifurcated end consisting or a pair of prongs 16 and 18 connected to one another by a spine member 20. The plate 14 has a aperture 22 therein through which a stud 24 is arranged to pass. The stud 24 has a thread 26 that engaged with a correspondingly threaded nut 28. Located on a first end the stud 24 is a cross bar 30 that passes through an aperture 32 in the stud 24 enabling a torque to be applied thereto. On the other end of the stud 24, is located a mandrel 34.

The mandrel 34 has a grub-screw 36 that engages with a groove 38 in the stud 24. The mandrel 34 as two shoulders 40 and 42 from which depend two neck members 44 and 46 respectively. A groove 48 is provided at the interface between respective shoulders 40 and 42 and neck members 44 and 46. The diameter of the shoulders 40 and 42 are selected to correspond with common external diameters of pipes, whereas the diameters of the neck portions 44 and 46 are selected to correspond with internal diameters of said pipes.

Accordingly, the neck 44 and 46 can be slid into the end of a pipe 50 and the shoulders 40 and 42 can be brought to bear against the end 52 of the pipe.

The mandrel 34 can conveniently be used in conjunction with two pipe 50 sizes. However, the mandrel 34 can also be removed by unscrewing the grub-screw 36 and replaced with a different mandrel having different dimensions to accord with different pipe diameters as desired.

The prongs 16 and 18 engage with the pipe fitting which bears against the olive during use. A support, or collet 54 may be provided to engage with the olive 56 located on the pipe 50. The collet could be part of a pipe fitting already on the pipe, in which case, the forks 16 and 18 would engage directly therewith.

Referring now to FIGS. 2A and B and FIGS. 3A and B, rotating the stud 24 using the cross bar 30 causes the neck 46 to slide within the end of the pipe 50, and eventually the shoulder 40 to engage with the top 52 of the pipe 50. Continuing to rotate the stud 24 causes the collet 54 to bear against the olive 56 imparting a sliding force thereto and the olive 56 slides off the end of the pipe 50 in the direction indicated by arrow A.

In FIGS. 2A and B and FIGS. 3A and B, the nut 28 is replaced by a threaded aperture 22 in the plate 14. A cross bar extension 58 can be used to increase the torque applied to the stud 24 for a given force by increasing the moment thereof. FIGS. 2 and 3 show different single size mandrels being used in conjunction with the same apparatus 10 to remove olives 56 from different sized pipes 50.

It is envisaged that the apparatus 10 will be manufactured largely or entirely of a, stiff, strong, resilient material such as steel. However, the apparatus 10 may be manufactured from a plastics material in certain circumstances. It is also envisaged that the apparatus 10 will be sold as a kit of parts comprising some or all or more than one of the following items: body 12, stud 24, mandrel 34, collet 54, allen key (not shown) for adjusting the grub-screw 36.

Turning to FIGS. 4A and 4B of the accompanying drawings, an apparatus 70 for removing fittings from pipes has a body 72 comprising a half cylinder 74 and ends 76 and 78 welded top and bottom of the cylinder half. The top end 76 is a disc, having a screw-threaded aperture 80 therethrough. The bottom end 78 is generally U-shaped having a slot 82, whereby the apparatus can be mounted about a pipe 84 from which a compression fitting (olive) 86 is to be removed.

Extending through the aperture 80 is a threaded stud 88 having at one end outside of the body a cross bar handle 90 for rotating the stud and at its other end a mandrel 92. The mandrel 92 is attached to the stud by means of a grub screw 94, so that it can be replaced by a differently sized mandrel for a different pipe diameter. Alternatively, as with the embodiment of FIG. 1, the mandrel may be shaped for use with different diameter pipes.

The mandrel 92 has a shoulder 96 and a neck portion 98. The neck portion 98 has an annular groove 100 adjacent the shoulder 96. The neck portion in use locates in the end of pipe 84 with the shoulder abutting the end of the pipe.

The end of the pipe 84 has a collet 104 around the pipe and fitting. The collet may be the screw threaded fitting used to connect the pipe to a corresponding fitting on another length of pipe.

The apparatus 70, having been fitted to a pipe end as shown with the mandrel bearing against the pipe end and the bottom end 78 of the body bearing against the collet 104, is used by rotating the stud 88 using the crossbar 90 to draw the mandrel and the body end 78 towards each other thereby forcing the compression fitting 86 off the pipe end.

Because of the shape of the body, the pipe end is visible and accessible so that heat can be directed onto the compression joint, such as by means of a blowtorch, to expand the fitting and render it easier to remove using the apparatus 70.

The annular groove 100 of the mandrel accommodates any burrs on the inside of the pipe end caused by cutting of the pipe to length that might otherwise cause the pipe to spread outwards under the action of the mandrel and begin to twist. Thus, the pipe end can collapse inwards.

Finally, FIG. 5 of the drawings shows an apparatus 120 for removing fittings from pipes of a similar type to that of FIG. 4 as shown with the addition of a saddle 122 onto the top end of stud 124. The saddle 122 enables the apparatus also to be used as an adjustable pipe support, such as for supporting a pipe in portion whilst a soldered connection is being made.

The stud 124 of the apparatus 120 can be rotated to alter the distance between the saddle and the base end 126 of the apparatus as desired.

1. Apparatus for removing a friction grip fitting from a pipe comprising a first engagement means for directly or indirectly engaging the friction grip fitting, a second engagement means for engaging the end of the pipe at a position spaced-apart from the friction grip fitting and means for applying a force to move the first and second engagement means with respect to one another to slide the friction grip fitting with respect to the pipe.

2. Apparatus as claimed in claim 1 comprising a body having first and second spaced ends and means connecting said ends.

3. Apparatus as claimed in claim 2, wherein the body is generally C-shaped to provide said ends and connecting means.

4. Apparatus as claimed in claim 2, wherein the body comprises one half of a cylinder with said ends mounted to the top and bottom of said half cylinder.

5. Apparatus as claimed in claim 2, wherein one of said ends provides the first engagement means.

6. Apparatus as claimed in claim 1, wherein the first engagement means comprises a bifurcated end or a pair of forks or prongs adapted to engage with the fitting.

7. Apparatus as claimed in claim 6, wherein the first engagement means may further comprise a collet member specifically adapted to engage a certain type of pipe fitting.

8. Apparatus as claimed in claim 1, wherein the second engagement means comprises a mandrel.

9. Apparatus as claimed in claim 8, wherein the mandrel has neck and shoulder portions adapted to slide into the end of a pipe and to bear against the end of the pipe respectively.

10. Apparatus as claimed in claim 8, wherein the mandrel has a plurality of shoulders and necks to accommodate various sized pipes.

11. Apparatus as claimed in claim 9, wherein a groove is provided at the interface between shoulder and neck portions.

12. Apparatus as claimed in claim 1, wherein the means for applying a force to move the first and second engagement means with respect to one another to slide the fitting with respect to the pipe comprises mechanical means capable of providing a substantially linear force between the first and second engagement means.

13. Apparatus as claimed in claim 12, wherein said force applying means comprises a piston.

14. Apparatus as claimed in claim 12, wherein said force applying means comprises a stud acting between the first and second engagement means.

15. Apparatus as claimed in claim 14, wherein the stud is arranged to engage with a fixed part of the apparatus and one of the engagement means.

16. Apparatus as claimed in claim 15, wherein the fixed part of the apparatus is said second end of the body.

17. Apparatus as claimed in claim 14, wherein a stud is provided that passes through a threaded aperture in the body of the apparatus and has a mandrel attached to an end thereof.

18. Apparatus as claimed in claim 17, wherein the stud has a crossbar for applying torque thereto to wind the stud either towards or away from an opposing engagement means.

19. Apparatus as claimed in claim 8, wherein the mandrel is removable and/or interchangeable with mandrels of differing sizes and/or geometries to suit the application.

20. Apparatus as claimed in claim 19, wherein the mandrel has a push or snap fit connector.

21. Apparatus as claimed in claim 19, wherein the mandrel is provided with a grub-screw adapted to engage with a groove or other formation in the stud.

22. Apparatus as claimed in claim 1 having height adjustable means for supporting a pipe.

23. Apparatus as claimed in claim 22, wherein the support means is a saddle or the like on the or a stud.

24. (canceled)
